(19) United States
(12) Patent Application Publication
(10) Pub. No.: US 2026/0080289 A1
(43) Pub. Date: Mar. 19, 2026

(54) Computer-Readable Recording Medium Storing Quantum Computation Support Program, Quantum Computation Support Method, and Information Processing Apparatus

(71) Applicant: Fujitsu Limited, Kawasaki-shi, Kanagawa (JP)

(72) Inventor: Sho TAKEMORI, Yokohama (JP)

(73) Assignee: Fujitsu Limited, Kawasaki-shi, Kanagawa (JP)

(21) Appl. No.: 18/809,974

(22) Filed: Aug. 20, 2024

(30) Foreign Application Priority Data
Oct. 4, 2023 (JP) 2023-172746

(51) Int. Cl. G06N 10/60

(52) U.S. Cl. CPC G06N 10/60

(57) ABSTRACT

A non-transitory computer-readable recording medium stores a quantum computation support program for causing a computer to execute a process including: training a regression model in which parameter values are explanatory variables and computation results of quantum computation are objective variables, based on a correspondence relationship between the computation results for each of a plurality of times of quantum computation for each of the parameter values according to a quantum circuit that includes parameters and the parameter values set in the quantum computation; and specifying a solution of the quantum computation by using the regression model.

### CROSS-REFERENCE TO RELATED APPLICATION

This application is based upon and claims the benefit of priority of the prior Japanese Patent Application No. 2023-172746, filed on Oct. 4, 2023, the entire contents of which are incorporated herein by reference.

### FIELD

The embodiments discussed herein are related to a computer-readable recording medium storing a quantum computation support program, a quantum computation support method, and an information processing apparatus.

### BACKGROUND

By using quantum chemical computation, it is possible to examine characteristics of an unknown substance. Highly accurate energy of a substance is computed by the quantum chemical computation. Energy in a ground state of a quantum multi-body system may be computed by, for example, a variational quantum eigensolver (VQE). The VQE is an algorithm using a noisy intermediate-scale quantum computer (NISQ) without error correction. The VQE is expected to be applied to drug discovery and new substance discovery.

“SPSA (Simultaneous Perturbation Stochastic Approximation)—A Method for System Optimization” [online], The Johns Hopkins University Applied Physics Laboratory, [searched on Sep. 19, 2023], Internet <URL: https (scheme name)://www.jhuapl.edu/SPSA/(host name+path name)>, and Knizia, Gerald, and Garnet Kin-Lic Chan, “Density Matrix Embedding: A Simple Alternative to Dynamical Mean-Field Theory”, Physical review letters, Nov. 2, 2012, Vol. 109, Iss. 18 are disclosed as related art.

### SUMMARY

According to an aspect of the embodiments, a non-transitory computer-readable recording medium stores a quantum computation support program for causing a computer to execute a process including: training a regression model in which parameter values are explanatory variables and computation results of quantum computation are objective variables, based on a correspondence relationship between the computation results for each of a plurality of times of quantum computation for each of the parameter values according to a quantum circuit that includes parameters and the parameter values set in the quantum computation; and specifying a solution of the quantum computation by using the regression model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a quantum computation support method according to a first embodiment;

FIG. 2 is a diagram illustrating an example of a system configuration according to a second embodiment;

FIG. 3 is a diagram illustrating an example of hardware of devices included in a quantum computation system;

FIG. 4 is a diagram illustrating an example of quantum chemical computation by a VQE;

FIG. 5 is a diagram illustrating an example of estimation by a Gaussian process or a kernel method using an optimization history;

FIG. 6 is a block diagram illustrating an example of functions of a quantum computer system;

FIG. 7 is a diagram illustrating an example of ground energy computation processing;

FIG. 8 is a flowchart illustrating an example of a procedure of regression model training processing;

FIG. 9 is a diagram illustrating an example of a regression model based on the Gaussian process or the kernel method;

FIG. 10 is a diagram illustrating an example of a solution based on the regression model by the Gaussian process or the kernel method; and

FIG. 11 is a flowchart illustrating an example of a procedure of regression model training processing including adjustment of a regularization parameter.

### DESCRIPTION OF EMBODIMENTS

In the VQE, parameters are optimized based on results of evaluating quantum circuits in the NISQ. For the optimization of the parameters, for example, a method such as a simultaneous perturbation stochastic approximation (SPSA) is used. The VQE may be used as a subroutine in a density matrix embedding theory (DMET). The DMET is a quantum embedding theory for computing a quantity that does not depend on a frequency such as ground state characteristics of an infinite system.

A solution obtained by search for an optimization solution using a quantum device including noise such as a NISQ may deviate from a true optimal solution due to an influence of noise. Such a solution error due to the influence of noise is a problem that occurs not only in the VQE but also in many quantum computations using the NISQ, such as a quantum approximate optimization algorithm (QAOA) which is an algorithm for combinatorial optimization and quantum computation using the VQE as a subroutine like the DMET.

In one aspect, an object of the present disclosure is to reduce an influence of noise in quantum computation.

Hereinafter, the present embodiments will be described with reference to the drawings. Each embodiment may be implemented by combining a plurality of embodiments within a range without contradiction.

### First Embodiment

A first embodiment is a quantum computation support method for suppressing an influence of noise in quantum computation.

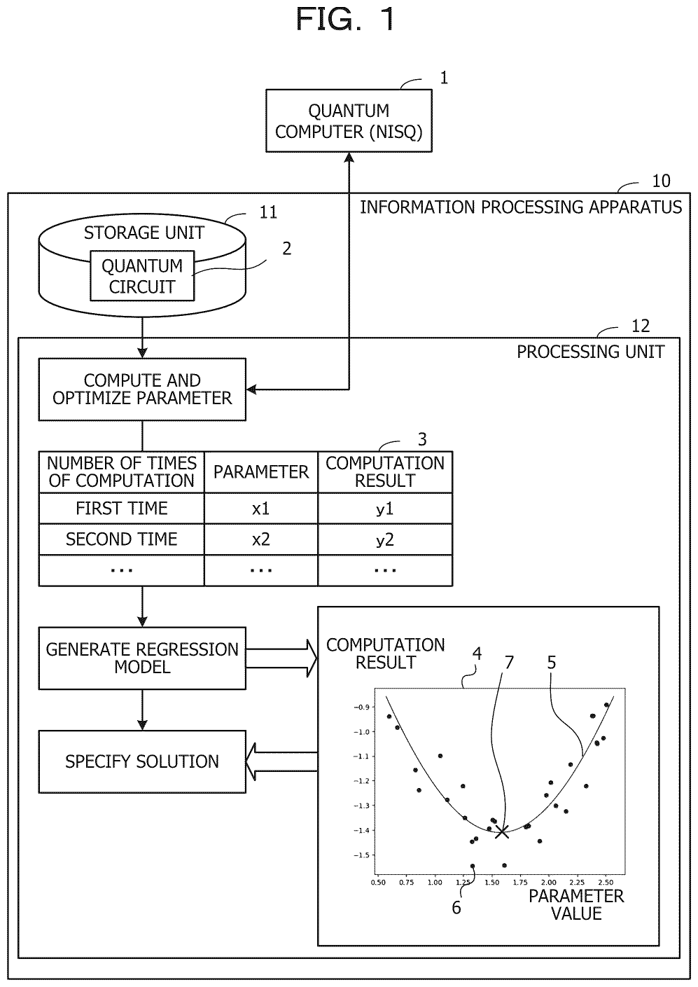

FIG. 1 is a diagram illustrating an example of a quantum computation support method according to the first embodiment. FIG. 1 illustrates an information processing apparatus 10 for performing the quantum computation support method. For example, by executing a quantum computation support program, the information processing apparatus 10 is able to perform the quantum computation support method.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

The storage unit 11 stores a quantum circuit 2 including a parameter. For example, the quantum circuit 2 includes a quantum gate that indicates a gate operation according to the parameter. As the quantum circuit 2 including a parameter, for example, there is a quantum circuit for obtaining a ground state of a quantum multi-body system. For example, in a case where a ground state of a quantum multi-body system is obtained by a VQE, the quantum circuit 2 including a quantum gate that performs a gate operation of rotation designated by an angle parameter is used.

Based on a computation result of the quantum computation using the quantum circuit 2, the processing unit 12 computes a solution 7 with a reduced influence of noise. For example, the processing unit 12 first acquires history information 3 indicating a correspondence relationship between a computation result and a parameter value.

For example, the processing unit 12 repeatedly executes processing (optimization) of updating the parameter value in a direction in which the computation result approaches a ground state, and processing of calculating the computation result based on the gate operation according to the quantum circuit 2 in which the updated parameter value is set. For example, the processing unit 12 may cause a quantum computer 1 to execute the gate operation according to the quantum circuit 2 in which the updated parameter value is set, and may calculate the computation result based on a measurement result by the quantum computer 1.

In a case where the quantum computer 1 is a NISQ, noise is included in the gate operation and the measurement according to the quantum circuit 2 by the quantum computer 1. For this reason, when points indicating a relationship between the parameter values and the computation results indicated in the history information 3 are plotted in a graph 4, variations due to noise occur at the plotted points. In the optimization processing, for example, a parameter value at a point where a value of a computation result indicating energy of a ground state is smallest is an optimization solution 6. However, an accuracy of the computation result may be lowered due to the influence of noise, and there is no guarantee that the optimization solution 6 is a true solution indicating the ground state.

Accordingly, the processing unit 12 trains (performs training of) a regression model 5 based on a correspondence relationship between computation results for each of a plurality of times of computation (quantum computation) for each of the parameter values according to the quantum circuit 2 and the parameter values set in the quantum computation. The regression model 5 is a model in which parameter values are explanatory variables and computation results are objective variables.

For example, the processing unit 12 trains the regression model 5 by using a Gaussian process (GP) or a kernel method. As a method of generating the regression model 5, there is a method such as linear regression or polynomial regression using a feature vector, but the linear regression or the polynomial regression may be regarded as a special case of the Gaussian process or the kernel method.

The processing unit 12 specifies the solution 7 of the quantum computation by using the regression model 5. For example, the processing unit 12 specifies a value of an explanatory variable at which a value of an objective variable takes an extreme value (for example, a minimum value) in the regression model 5, as the solution 7 of the quantum computation.

As described above, by training the regression model 5 based on the history information 3 and specifying the solution 7 by using the regression model 5, it is possible to obtain the solution 7 with a reduced influence of noise included at the time of computation based on the quantum circuit 2. For example, it is possible to obtain the solution 7 having a small error from a true optimal solution.

Since the influence of noise is allowed to be included in the history information 3, the processing unit 12 may acquire the history information 3 by using an optimization method with a small processing load such as an SPSA. Accordingly, the processing load for specifying the solution 7 with a reduced influence of noise is small.

The processing unit 12 may specify a solution in consideration of uncertainty of estimation of the value of the objective variable in the regression model 5. For example, the processing unit 12 computes uncertainty of estimation of an objective variable according to an explanatory variable of the regression model 5 by the Gaussian process or the kernel method. The processing unit 12 specifies the solution 7 of the quantum computation from a range of values of the explanatory variable in which the uncertainty of estimation of the objective variable is equal to or greater than a predetermined value (reliability of an estimated value is high). Accordingly, it is possible to obtain the solution 7 having a small error from a true optimal solution.

The Gaussian process or the kernel method is effective for learning a smooth function from a relatively small amount of data. In the current NISQ, a number of iterations of optimization is not very large, and there is not a large amount of data. For this reason, by using the Gaussian process or the kernel method, it is possible to generate the regression model 5 with a high accuracy even when the number of iterations of optimization is small.

Based on the correspondence relationship between the computation results and the parameter values, the processing unit 12 may train regression model candidates to which each of a plurality of regularization parameters is applied. In this case, the processing unit 12 determines a regression model based on a predetermined condition from among the regression model candidates for each of the plurality of regularization parameters.

For example, a computation result using the quantum circuit 2 having parameters is a smooth function with respect to the parameters when there is no noise. In a case of the simple quantum circuit 2 having one parameter, the function is a trigonometric function. More generally, even in a case of the quantum circuit 2 having a plurality of parameters, when one parameter is focused on, a function corresponding to the representative quantum circuit 2 is a trigonometric function. Accordingly, the processing unit 12 may determine the regression model 5 based on consistency with the trigonometric function from among the regression model candidates for each of the plurality of regularization parameters.

By determining a regression model based on the predetermined condition from among the regression model candidates for each of the plurality of regularization parameters, it is possible to obtain the regression model 5 using an appropriate regularization parameter even when the appropriate regularization parameter is unknown. When there is no influence of noise in the optimization, it may be known that the regression model 5 is represented by a trigonometric function. In such a case, by specifying a regression model having high consistency with the trigonometric function among the plurality of regression model candidates as the regression model 5, a regression model candidate to which an appropriate regularization parameter is applied may be correctly specified as the regression model 5.

### Second Embodiment

A second embodiment is to suppress an influence of noise in quantum chemical computation using a VQE and improve an accuracy of a solution. The quantum chemical computation is to obtain energy of a quantum multi-body system (a type of molecule+a ground function). The ground function is a function that is a source constituting a molecular orbital. By obtaining the energy of the quantum multi-body system, it is possible to grasp characteristics of the molecule. The energy to be obtained includes ground energy and excitation energy. The ground energy is energy in a state where a molecular structure is stable. The excitation energy is energy in a state where a molecular structure is unstable. Among possible states of the molecule, energy in a state where the energy is minimum is the ground energy.

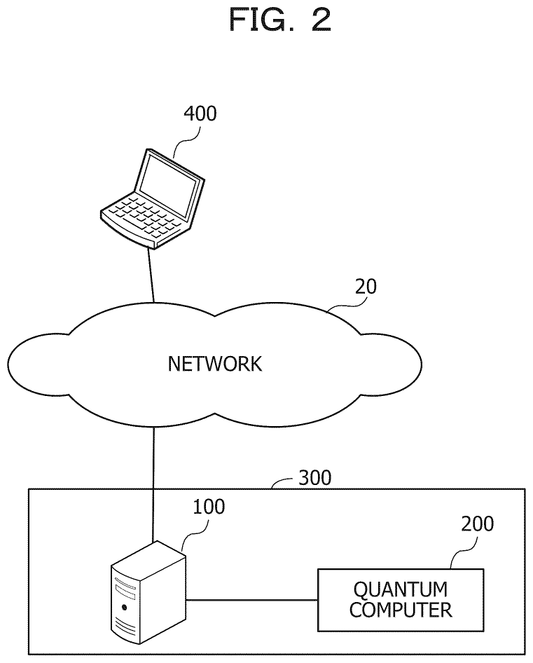

FIG. 2 is a diagram illustrating an example of a system configuration according to the second embodiment. In the second embodiment, a quantum computer system 300 and a terminal device 400 are coupled to each other via a network 20. The terminal device 400 transmits a request for quantum computation to the quantum computer system 300 in response to an operation from a user.

The quantum computer system 300 includes a classical computer 100 and a quantum computer 200. The classical computer 100 and the quantum computer 200 are coupled to each other via a communication interface. The classical computer 100 is a Neumann-type computer, and performs processing such as generation of a quantum circuit and optimization of parameters used for computation of the quantum circuit. The quantum computer 200 is a computer that performs the quantum chemical computation by performing an operation based on a quantum gate on a quantum bit. The quantum computer 200 performs quantum chemical computation by a VQE algorithm in accordance with the quantum circuit and the parameters generated by the classical computer 100.

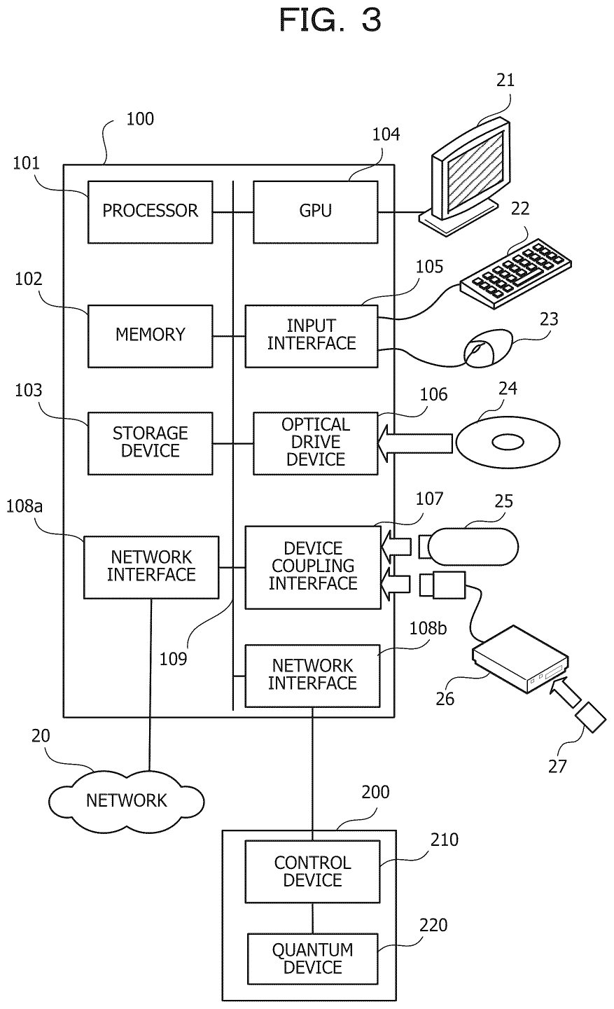

FIG. 3 is a diagram illustrating an example of hardware of devices included in the quantum computation system. The entirety apparatus of the classical computer 100 is controlled by a processor 101. A memory 102 and a plurality of peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least a part of the function realized by the processor 101 executing a program may be realized by an electronic circuit such as an application-specific integrated circuit (ASIC) or a programmable logic device (PLD).

The memory 102 is used as a main storage device of the classical computer 100. The memory 102 temporarily stores at least a part of an operating system (OS) program or an application program to be executed by the processor 101. The memory 102 stores various types of data to be used for the processing by the processor 101. As the memory 102, for example, a volatile semiconductor storage device such as a random-access memory (RAM) is used.

The peripheral devices coupled to the bus 109 include a storage device 103, a graphics processing unit (GPU) 104, an input interface 105, an optical drive device 106, a device coupling interface 107, and network interfaces 108a and 108b.

The storage device 103 writes and reads data electrically or magnetically to and from a built-in recording medium. The storage device 103 is used as an auxiliary storage device of the classical computer 100. The storage device 103 stores an OS program, an application program, and various types of data. As the storage device 103, for example, a hard disk drive (HDD) or a solid-state drive (SSD) may be used.

The GPU 104 is a calculation device that performs image processing. The GPU 104 is an example of a graphic controller. A monitor 21 is coupled to the GPU 104. The GPU 104 displays an image on a screen of the monitor 21 in accordance with a command from the processor 101. As the monitor 21, a display device using organic electro luminescence (EL), a liquid crystal display device, or the like is used.

A keyboard 22 and a mouse 23 are coupled to the input interface 105. The input interface 105 transmits signals transmitted from the keyboard 22 or the mouse 23 to the processor 101. The mouse 23 is an example of a pointing device, and other pointing devices may be used. Examples of the other pointing devices include a touch panel, a tablet, a touch pad, a track ball, or the like.

The optical drive device 106 reads data recorded in an optical disc 24 or writes data to the optical disc 24 by using laser light or the like. The optical disc 24 is a portable-type recording medium in which data is recorded such that the data is readable by reflection of light. Examples of the optical disc 24 include a Digital Versatile Disc (DVD), a DVD-RAM, a compact disc read-only memory (CD-ROM), a CD-recordable (CD-R), a CD-rewritable (CD-RW), and the like.

The device coupling interface 107 is a communication interface for coupling the peripheral devices to the classical computer 100. For example, a memory device 25 or a memory reader and writer 26 may be coupled to the device coupling interface 107. The memory device 25 is a recording medium provided with a function of communicating with the device coupling interface 107. The memory reader and writer 26 is a device that writes data to a memory card 27 or reads data from the memory card 27. The memory card 27 is a card-type recording medium.

The network interface 108a is coupled to the network 20. The network interface 108a transmits and receives data to and from another computer or a communication device via the network 20. The network interface 108a is, for example, a wired communication interface that is coupled to a wired communication device such as a switch or a router by a cable. The network interface 108a may be a wireless communication interface that is coupled, by radio waves, to and communicates with a wireless communication device such as a base station or an access point.

The network interface 108b is an interface for coupling to the quantum computer 200. The processor 101 transmits a quantum circuit to the quantum computer 200 via the network interface 108b and causes the quantum computer 200 to execute quantum computation. The processor 101 acquires a result of the quantum computation via the network interface 108b.

With the hardware as described above, the classical computer 100 may realize processing functions of the second embodiment. The information processing apparatus 10 described in the first embodiment may also be realized by substantially the same hardware as that of the classical computer 100 illustrated in FIG. 3.

For example, the classical computer 100 realizes the processing functions of the second embodiment by executing a program recorded in a computer-readable recording medium. The program in which a content of processing to be executed by the classical computer 100 is described may be recorded in any of various recording media. For example, the program to be executed by the classical computer 100 may be stored in the storage device 103. The processor 101 loads at least a part of the program in the storage device 103 to the memory 102, and executes the program. The program to be executed by the classical computer 100 may be recorded in a portable-type recording medium such as the optical disc 24, the memory device 25, or the memory card 27. The program stored in the portable-type recording medium may be executed after the program is installed in the storage device 103 under the control of the processor 101, for example. The processor 101 may read the program directly from the portable-type recording medium and execute the program.

The quantum computer 200 has a control device 210 and a quantum device 220. The control device 210 executes a gate operation on a quantum bit in the quantum device according to the quantum circuit. The quantum device 220 has a plurality of quantum bits. The quantum device 220 is, for example, a quantum processing unit (QPU).

In the quantum computer system 300, by the classical computer 100 and the quantum computer 200 operating in cooperation with each other, quantum chemical computation by a VQE is performed. At this time, since the quantum computer 200 is a NISQ, an accuracy of an optimization solution obtained by the VQE is reduced due to an influence of noise.

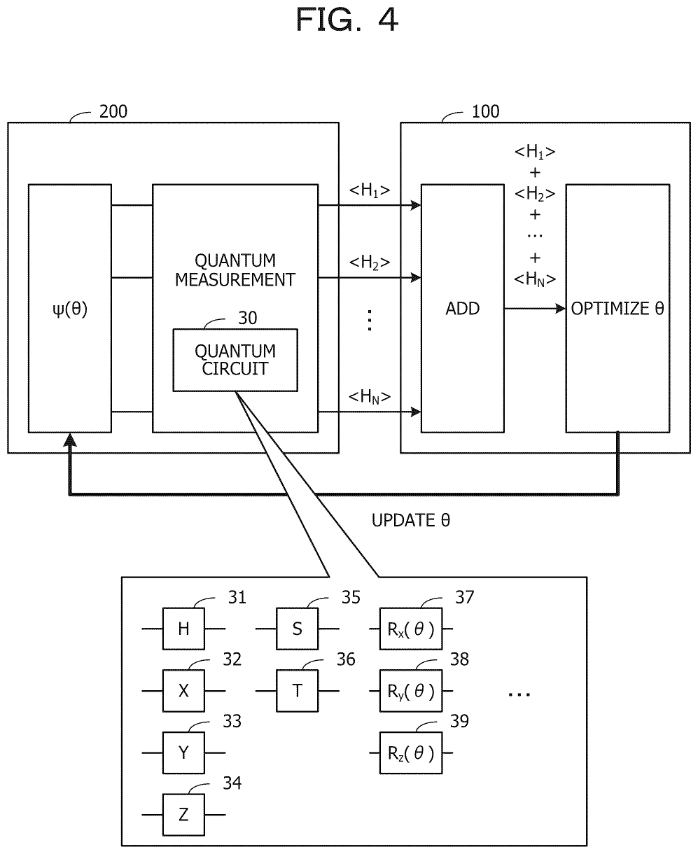

FIG. 4 is a diagram illustrating an example of the quantum chemical computation by the VQE. In the quantum chemical computation by the VQE, the quantum computer 200 performs quantum measurement based on an initial value of a parameter θ (a set of variables of a circuit corresponding to electron excitation). For example, the quantum computer 200 calculates a values of each of a plurality of divided Hamiltonians (H₁, H₂, . . . , and H_{N}) in accordance with the quantum circuit (N is a natural number).

An Ansatz circuit is included in a quantum circuit 30 used for the quantum measurement. The quantum circuit 30 is a quantum computation model described by combining a plurality of quantum gates. The quantum gates include an Hadamard gate 31, an X gate 32, a Y gate 33, a Z gate 34, an S gate 35, a T gate 36, and a rotation gate 37 to a rotation gate 39, and so on.

A gate operation of the Hadamard gate 31 is represented by Expression (1).

$$H = \frac{1}{\sqrt{2}} ( \begin{matrix}1 & 1 \\ 1 & - 1\end{matrix} ) \qquad ( 1 )$$

A gate operation of the X gate 32 is represented by Expression (2).

$$X = ( \begin{matrix}0 & 1 \\ 1 & 0\end{matrix} ) \qquad ( 2 )$$

A gate operation of the Y gate 33 is represented by Expression (3).

$$Y = ( \begin{matrix}0 & - i \\ i & 0\end{matrix} ) \qquad ( 3 )$$

A gate operation of the Z gate 34 is represented by Expression (4).

$$Z = ( \begin{matrix}1 & 0 \\ 0 & - 1\end{matrix} ) \qquad ( 4 )$$

A gate operation of the S gate 35 is represented by Expression (5).

$$S = ( \begin{matrix}1 & 0 \\ 0 & i\end{matrix} ) \qquad ( 5 )$$

A gate operation of the T gate 36 is represented by Expression (6).

$$T = ( \begin{matrix}1 & 0 \\ 0 & {e}^{i π / 4}\end{matrix} ) \qquad ( 6 )$$

A gate operation of the rotation gate 37 that rotates a state around an X axis by an angle indicated by the parameter θ is represented by Expression (7).

$${R}_{x} ( θ ) = ( \begin{matrix}cos θ / 2 & - i sin θ / 2 \\ - i sin θ / 2 & cos θ / 2\end{matrix} ) \qquad ( 7 )$$

A gate operation of the rotation gate 38 that rotates a state around a Y axis by the angle indicated by the parameter θ is represented by Expression (8).

$${R}_{y} ( θ ) = ( \begin{matrix}cos θ / 2 & - sin θ / 2 \\ sin θ / 2 & cos θ / 2\end{matrix} ) \qquad ( 8 )$$

A gate operation of the rotation gate 39 that rotates a state around a Z axis by the angle indicated by the parameter θ is represented by Expression (9).

$${R}_{z} ( θ ) = ( \begin{matrix}{e}^{- i θ / 2} & 0 \\ 0 & {e}^{i θ / 2}\end{matrix} ) \qquad ( 9 )$$

Although all of the quantum gates illustrated in FIG. 4 are 1-qubit gates, quantum gates (for example, 2-qubit gates) that operate a plurality of quantum bits are also used in the quantum circuit 30.

As the quantum gates used in the quantum circuit 30, there are quantum gates for which a rotation angle is designated by the parameter θ, like the rotation gates 37 to 39. When the quantum circuit 30 includes a plurality of rotation gates, the value of the parameter θ for each rotation gate is designated. The quantum computer 200 executes quantum computation by applying the designated value of the parameter θ and performing a gate operation according to the quantum circuit 30 on the quantum bit. As a result, a plurality of divided Hamiltonians are calculated.

The plurality of calculated Hamiltonians are added by the classical computer 100 to obtain an expected value of energy of the entire system. The classical computer 100 performs optimization of one or a plurality of parameters θ based on the expected value of energy. For example, the classical computer 100 updates the parameter θ in a direction in which the expected value of energy decreases. After the parameter θ is updated, the quantum computer 200 computes the expected value of energy based on the updated parameter θ again.

Such computation of the expected value of energy and the update of the parameter are repeated until ground energy is obtained. An example of the parameter optimization method is an SPSA. The SPSA is an algorithm in consideration of inclusion of noise in function evaluation. Although it is indicated that a good solution is obtained by taking an average for a number of optimization trials in the SPSA, a returned solution is easily influenced by noise in one trial with randomness. Under the influence of noise, an error occurs between a solution output by the optimization and a true optimal solution.

Accordingly, to reduce the influence of noise, estimation using a Gaussian process or a kernel method may be considered. At this time, when training based on the Gaussian process or the kernel method is performed in the middle of the optimization, estimation computation by the Gaussian process or the kernel method is performed a plurality of times, and a computation amount becomes excessive. A combination method of the estimation by the Gaussian process or the kernel method and the optimization method such as the SPSA for which results in the NISQ are known is not obvious, and there is a possibility that the influence of noise may not be sufficiently suppressed.

As methods of optimizing while removing the influence of noise, there are an implicit filtering algorithm (IMFIL), Bayesian optimization, and the like. The IMFIL is a method of removing high-frequency vibration from a function by discrete Fourier transform, and does not remove noise with randomness. For example, the IMFIL is a method of optimizing while estimating a smoothed function by using the discrete Fourier transform. Because the IMFIL is an optimization method, there is a possibility that noise that may not be reduced by the discrete Fourier transform may be reduced by post-processing using a regression model described later.

The Bayesian optimization is an optimization method for estimating a model of a function by using a Gaussian process or a kernel method. Because the Bayesian optimization performs estimation in each iteration of optimization, a computation amount is larger than that of other methods such as a stochastic gradient descent method.

There is also a technology in which noise reduction by a Gaussian process or a kernel method is used for optimizing in the NISQ. For example, “GP+IMFIL” uses a Gaussian process or a kernel method for an initial point of the IMFIL (local search method). Although a better initial point may be obtained, an influence of noise may remain in a solution returned by the local search method.

Accordingly, the quantum computer system 300 estimates a true optimal solution by the Gaussian process or the kernel method by using a history of optimization performed in the process of the VQE computation.

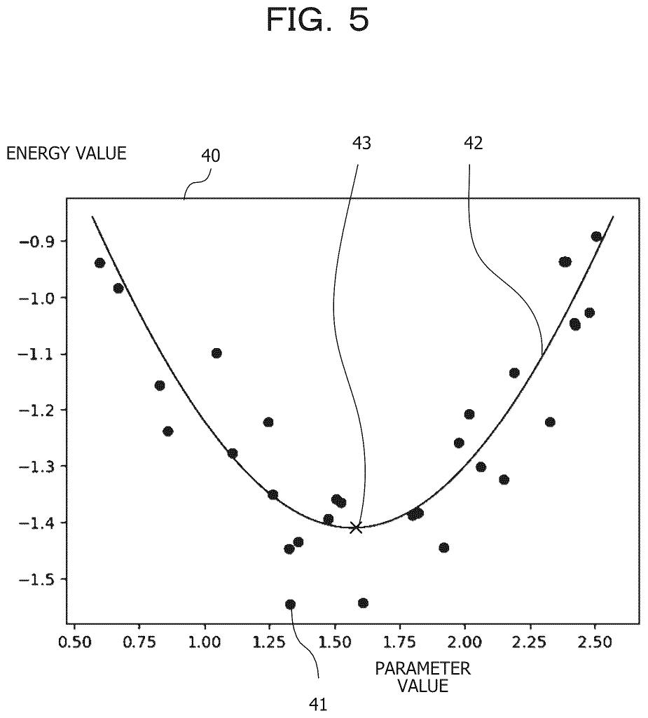

FIG. 5 is a diagram illustrating an example of estimation by a Gaussian process or a kernel method using an optimization history. A graph 40 indicates a relationship between a value of a parameter (one dimension) included in an energy computation expression and an energy value. A horizontal axis of the graph 40 indicates a parameter value, and a vertical axis of the graph 40 indicates an energy value.

Points in the graph 40 indicate parameter values obtained by optimization processing performed in the process of the VQE computation and energy values obtained from computation results of the quantum circuit when these parameter values are input. A point 41 at which an energy value is minimum is a solution of the quantum computation by the VQE computation. As illustrated in the graph 40, the energy value obtained by the quantum computation for each parameter has an error due to an influence of noise.

It is possible to generate a regression model 42 indicating the relationship between the parameter values and the energy values based on the history of optimization performed in the process of the VQE computation. The regression model 42 is a function in which the parameter values are explanatory variables and the energy values are objective variables. The regression model 42 is obtained as a result of estimation by a Gaussian process or a kernel method, for example. A curve coupling expected values of the energy values according to the parameter values is the regression model 42.

A parameter value at a point 43 at which an energy value is minimum in the regression model 42 is shifted from a parameter value at the point 41 at which the energy is minimum in the quantum computation. By setting the parameter value and the energy value corresponding to the point 43 as a solution for the optimization computation, a solution in which the influence of noise is suppressed is obtained.

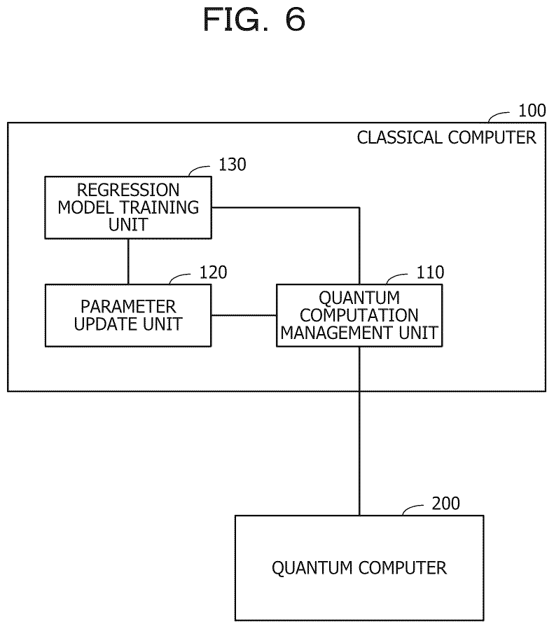

FIG. 6 is a block diagram illustrating an example of functions of the quantum computer system. The classical computer 100 includes a quantum computation management unit 110, a parameter update unit 120, and a regression model training unit 130.

The quantum computation management unit 110 acquires a quantum circuit for computing energy of a quantum multi-body system such as a molecule. For example, the quantum computation management unit 110 acquires a quantum circuit for performing optimization computation by the VQE algorithm from the terminal device 400. The quantum computation management unit 110 instructs the quantum computer 200 to perform quantum computation based on the acquired quantum circuit.

For example, the quantum computation management unit 110 sets initial values for a plurality of parameter values before the first quantum computation. The quantum computation management unit 110 acquires a computation result based on the quantum circuit parameterized by the plurality of parameters from the quantum computer 200. After that, the quantum computation management unit 110 acquires updated parameter values from the parameter update unit 120. The quantum computation management unit 110 instructs the quantum computer 200 to perform computation based on the quantum circuit in which the updated parameter values are set.

Based on the measurement result by the quantum computer 200, the quantum computation management unit 110 computes an energy value according to the set parameter value. For example, the quantum computation management unit 110 sets a sum of values of divided Hamiltonians as energy. When the energy value converges, the quantum computation management unit 110 sets the energy value at that time as ground energy. When the energy value has not converged, the quantum computation management unit 110 instructs the parameter update unit 120 to update the parameters.

In a case where an optimal solution of the parameter in a case where the influence of noise is reduced is acquired from the regression model training unit 130, the quantum computation management unit 110 instructs the quantum computer 200 to perform quantum computation based on this optimal solution. Based on the measurement result by the quantum computer 200, the quantum computation management unit 110 computes an energy value according to the optimal solution.

For each quantum computation, the parameter update unit 120 updates all or some values of the plurality of parameters in a direction in which the energy value decreases. The parameter update unit 120 notifies the quantum computation management unit 110 of the updated plurality of parameter values.

Based on the plurality of parameter values for each quantum computation and the energy values obtained by the quantum computation, the regression model training unit 130 trains a regression model indicating a relationship between the parameter values and the energy values. For example, the regression model training unit 130 generates a regression model by a Gaussian process or a kernel method. Based on the regression model obtained by the training, the regression model training unit 130 computes an optimal solution for the parameter values with a reduced influence of noise. The regression model training unit 130 instructs the quantum computation management unit 110 to perform quantum computation based on the optimal solution of the parameter values.

For example, the function of each element in the classical computer 100 illustrated in FIG. 6 may be realized by causing a computer to execute a program module corresponding to the element.

By such a quantum computer system 300, ground energy computation with a reduced influence of noise is performed.

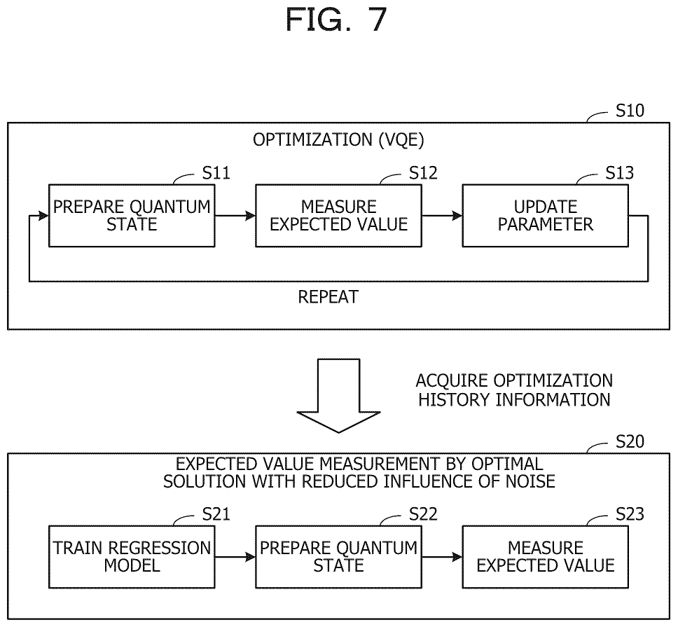

FIG. 7 is a diagram illustrating an example of ground energy computation processing. The ground energy computation processing by the quantum computer system 300 is roughly divided into optimization processing (step S10) by the VQE and expected value measurement processing (step S20) by the optimal solution with a reduced influence of noise.

First, quantum state preparation processing (step S11) is performed in the optimization processing (step S10). For example, the quantum computation management unit 110 instructs the quantum computer 200 to perform a gate operation for setting a quantum bit to a predetermined initial state. The quantum computer 200 sets the quantum bit to the initial state as instructed.

After the quantum state preparation processing (step S11) is completed, expected value measurement processing (step S12) is performed. For example, the quantum computation management unit 110 instructs the quantum computer 200 to execute a quantum gate operation based on a quantum circuit for performing a VQE. According to the instruction, the quantum computer 200 performs the quantum gate operation. After the quantum gate operation according to the quantum circuit, the quantum computer 200 measures a state of the designated quantum bit. For example, the quantum computer 200 repeats the quantum gate operation based on the quantum circuit and the measurement a predetermined number of times, and transmits an expected value of the state of the quantum bit to be measured to the quantum computation management unit 110.

The quantum computation management unit 110 computes energy based on the expected value of the state of the quantum bit. The parameter update unit 120 performs parameter update processing (step S13). In the parameter update processing (step S13), the parameter update unit 120 updates values of at least some of the plurality of parameters so as to reduce energy. For example, the parameter update unit 120 updates the parameter values by an SPSA.

After the parameter values are updated, the quantum state preparation processing (step S11), the expected value measurement processing (step S12), and the parameter update processing (step S13) are performed based on the quantum circuit parameterized by the updated parameters. The quantum state preparation processing (step S11), the expected value measurement processing (step S12), and the parameter update processing (step S13) are repeated until the computed energy value is determined as ground energy.

By the optimization processing (step S10), sets of parameter values and energy values when these parameter values are applied are recorded as history information in the memory 102 or the storage device 103. By acquiring the recorded history information, the expected value measurement processing (step S20) by the optimal solution with a reduced influence of noise is executed.

Regression model training processing (step S21), quantum state preparation processing (step S22), and expected value measurement processing (step S23) are executed in the expected value measurement processing (step S20) by the optimal solution with a reduced influence of noise.

In the regression model training processing (step S21), for example, the regression model training unit 130 trains a regression model by a Gaussian process or a kernel method. Based on the trained regression model, the regression model training unit 130 computes the optimal solution with a reduced influence of noise. The optimal solution is a parameter value that minimizes an energy value.

After the optimal solution is obtained, the quantum state preparation processing (step S22) is performed based on the optimal solution. For example, the quantum computation management unit 110 instructs the quantum computer 200 to perform a gate operation for setting a quantum bit to a predetermined initial state. The quantum computer 200 sets the quantum bit to the initial state as instructed.

After the quantum state preparation processing (step S22) is completed, the expected value measurement processing (step S23) is performed. For example, the quantum computation management unit 110 instructs the quantum computer 200 to execute a quantum gate operation based on a quantum circuit for performing a VQE. According to the instruction, the quantum computer 200 performs the quantum gate operation. After the quantum gate operation according to the quantum circuit, the quantum computer 200 measures a state of the designated quantum bit. For example, the quantum computer 200 repeats the quantum gate operation based on the quantum circuit and the measurement a predetermined number of times, and transmits an expected value of the state of the quantum bit to be measured to the quantum computation management unit 110. Based on the expected value of the state of the quantum bit, the quantum computation management unit 110 computes energy according to the optimal solution.

Energy computation may be performed by a quantum simulator or the like by using the optimal solution with a reduced influence of noise in the expected value measurement processing (step S20) by the optimal solution with a reduced influence of noise. In this case, quantum simulation by quantum simulator software is performed instead of the quantum state preparation processing (step S22) and the expected value measurement processing (step S23). The quantum simulation is processing of obtaining a change in a state of a quantum bit in response to the quantum gate operation indicated by the quantum circuit, by computation using the classical computer 100. By performing the energy computation with the quantum simulator, an energy value from which the influence of noise is removed is obtained.

The regression model training processing (step S21) based on the optimization history information will be described in detail next.

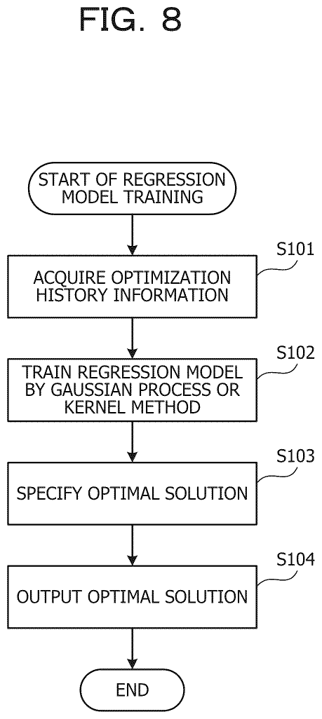

FIG. 8 is a flowchart illustrating an example of a procedure of the regression model training processing. Hereinafter, the processing illustrated in FIG. 8 will be described in order of step numbers.

[Step S101] The regression model training unit 130 acquires optimization history information. The optimization history information is a history of sets of parameters and observed values (for example, energy values).

It is assumed that a parameter of the quantum circuit is xₙ. xₙ is a vector of R^{d} (R^{d} is a real number space in which a number of dimensions is d (a natural number)). n={1, 2, . . . , and N} (N is a number of iterations of optimization processing). x_{N} is a solution obtained in the optimization processing.

It is assumed that a measurement result when the quantum circuit having xₙ as the parameter is executed by the quantum computer 200 is yₙ. At this time, history information is {(x₁, y₁), (x₂, y₂), . . . , and (x_{N}, y_{N})}.

[Step S102] Based on the acquired history information, the regression model training unit 130 trains a regression model by a Gaussian process or a kernel method. The regression model is represented by a function in which parameters are explanatory variables and observed values are objective variables.

[Step S103] The regression model training unit 130 specifies a parameter value that minimizes the function estimated by the Gaussian process or the kernel method, as an optimal solution with a reduced influence of noise. For example, in the function obtained by the Gaussian process or the kernel method, the regression model training unit 130 specifies x* that minimizes an estimated value of the function in the vicinity of x_{N}, as the optimal solution with a reduced influence of noise.

The regression model training unit 130 may specify the optimal solution with a reduced influence of noise, from among the parameter values with which reliability of the energy value estimated by the regression model is equal to or greater than a certain value. For example, in a case where a number of samples (sets of parameter values and energy values) of the history information is small, the reliability of estimation by the Gaussian process or the kernel method is low. In this case, the regression model training unit 130 specifies the optimal solution with a reduced influence of noise from among the parameter values with which the reliability is equal to or greater than a certain level, thereby suppressing an incorrect optimal solution from being specified due to the small number of samples.

[Step S104] The regression model training unit 130 outputs the optimal solution with a reduced influence of noise.

As described above, by training the regression model based on the optimization history information, it is possible to obtain the optimal solution with a reduced influence of noise. By using the Gaussian process or the kernel method as the regression model, the regression model training unit 130 may determine the optimal solution in consideration of uncertainty of estimation.

Details of the Gaussian process or the kernel method will be described below.

In the Gaussian process or the kernel method, it is assumed that X is a parameter space, and “k: X×X→R” (R is a real number space) is a kernel. The kernel represents similarity between two parameters, and as the kernel, for example, a Matern kernel, a Squared Exponential kernel, or the like is used.

The history information that is sets of parameters and

measurement values for respective expected value measurements in the optimization processing is {(x₁, y₁), (x₂, y₂), . . . , and (x_{N}, y_{N})}. It is assumed that Kₙ is an n-th order square matrix in which (i, j) component is k(xᵢ, xⱼ) (i and j are natural numbers). It is assumed that a column vector whose i component is k(x, xᵢ) when x is a parameter is kₙ(x).

It is assumed that λ is a regularization parameter (λ>0). The regularization parameter is a value by which a regularization term included in an expression representing a regression model is multiplied. The regularization term is a term for smoothing noise. By using the regularization parameter, how much noise is smoothed is adjusted. An estimation μₙ(x) in the Gaussian process or the kernel method is given by Expression (10) below.

$${μ}_{n} ( x ) = ( {y}_{1} , … , {y}_{n} ) {( {K}_{n} + λ {1}_{n} )}^{- 1} {k}_{n} ( x ) \qquad ( 10 )$$

Uncertainty σₙ(x) of estimation is given by Expression (11) below.

$${σ}_{n} ( x ) = \sqrt{k ( x , x ) - {k}_{n}^{T} ( x ) {K}_{n}^{- 1} {k}_{n} ( x )} \qquad ( 11 )$$

The uncertainty of estimation indicates a level of possibility that a value of the estimation μₙ(x) is correct. A width of a confidence interval of the estimation μₙ(x) is defined by the uncertainty of estimation. As the width of the confidence interval is narrower, the probability that the value of the estimation μₙ(x) is correct is higher (reliability is higher).

When such a Gaussian process or a kernel method is applied to the history information of the VQE, the parameter θ of an angle in the VQE is used as a parameter x in Expression (10) and Expression (11). A value obtained by the estimation is an energy value. By estimating the energy value according to the parameter by a Gaussian process or a kernel method, uncertainty of this energy value may also be calculated.

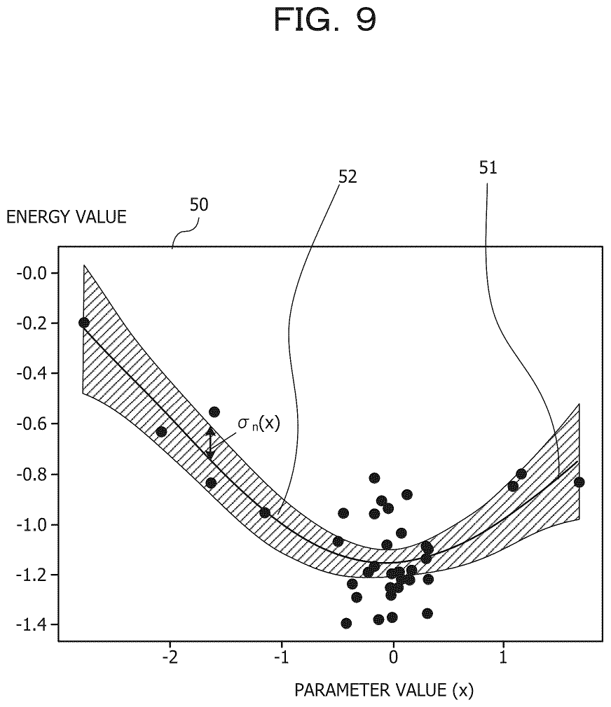

FIG. 9 is a diagram illustrating an example of the regression model based on the Gaussian process or the kernel method. A horizontal axis of a graph 50 indicates a parameter value and a vertical axis of the graph 50 indicates an energy value. Points in the graph 50 indicate samples included in the history information. Based on the parameter values and the energy values indicated by the samples, the Gaussian process or the kernel method is learned, and a regression model 51 is obtained. The regression model 51 is a function represented by Expression (10). A width of a confidence interval 52 in an energy value direction is represented by Expression (11). For example, the confidence interval 52 is represented by [μₙ(x)−σₙ(x), μₙ(x)+σₙ(x)].

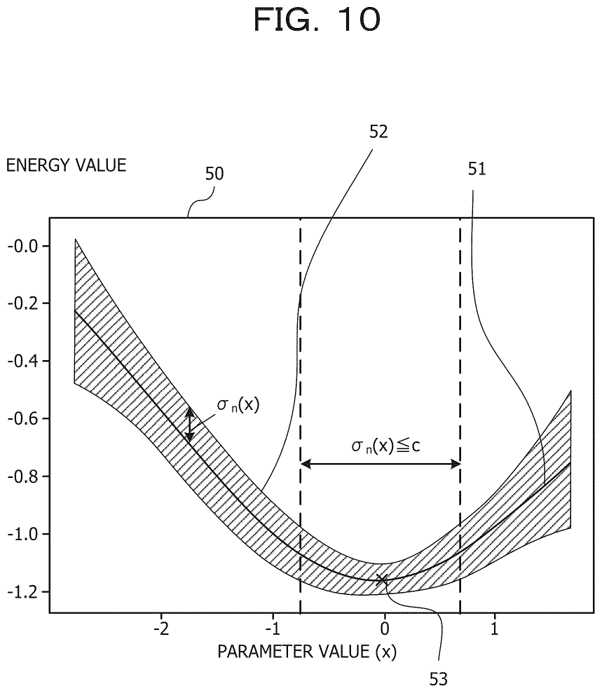

FIG. 10 is a diagram illustrating an example of a solution based on the regression model by the Gaussian process or the kernel method. For example, a constraint condition “σₙ(x)≤c” (c is a positive real number) is provided in a case where an optimal solution with a reduced influence of noise is specified from among parameter values with which reliability is equal to or greater than a certain level. In the example of the graph 50, a region that satisfies the constraint condition is a region surrounded by broken lines. Outside the region surrounded by the broken lines, the reliability of the estimation μₙ(x) is low (uncertainty σₙ(x) is large). For this reason, the regression model training unit 130 computes optimization “min μₙ(x)” only in the region surrounded by the broken lines.

As described above, in a case where the number of samples is small, the regression model training unit 130 does not search the estimation μₙ(x) from the entire region, but obtains a point 53 that minimizes μₙ(x) by narrowing down to a region having low uncertainty, and sets a parameter value of the point 53 as an optimal solution x* with a reduced influence of noise. This may be expressed as Expression below.

$${x}^{*} = {min}_{x} {μ}_{n} ( x ) s . t . {σ}_{n} ( x ) \leq c \qquad ( 12 )$$

Accordingly, the optimal solution is specified in an interval with high reliability. Consequently, it is possible to obtain a highly reliable optimal solution.

At the time of minimizing the function, the regression model training unit 130 may set a parameter x having small uncertainty σₙ(x) and small estimation μₙ(x) as the optimal solution. For example, the regression model training unit 130 sets a parameter x that minimizes “μₙ(x)+a×σₙ(x)” (a is a real number larger than 0) as the optimal solution.

As described above, it is possible to obtain the optimal solution with a reduced influence of noise by training the regression model using the Gaussian process or the kernel method based on the optimization history information and setting the parameter value that minimizes the energy value in this regression model as the optimal solution.

Since training based on the Gaussian process or the kernel method is performed as post-processing of the optimization method, the computation amount may be reduced as compared with a method in which training based on the Gaussian process or the kernel method is performed a plurality of times during optimization. Since it is post-processing of the optimization method, it may be used in combination with arbitrary optimization method.

By specifying an optimal solution in a region with high reliability, an optimal solution with high reliability is obtained.

### Third Embodiment

A third embodiment is to, when an appropriate regularization parameter is unknown, allow an optimal solution to be calculated by computation using the appropriate regularization parameter.

The regularization parameter is a parameter indicating how much noise is smoothed when the Gaussian process or the kernel method is learned. Because an intensity of noise is unknown in the NISQ, it is difficult to know in advance how to set the regularization parameter.

Many of functions when energy is minimized by using a quantum circuit such as a VQE are trigonometric functions when one dimension of a parameter is focused. Accordingly, in the quantum computer system 300, the regularization parameter is adjusted so as to well represent the trigonometric function (to increase consistency). Assuming that a parameter to be optimized is x, a trigonometric function representing energy is, for example, “a sin (x+x₀)+b” or “a sin (2 (x+x₀))+b” (a, b, and x₀ are real numbers).

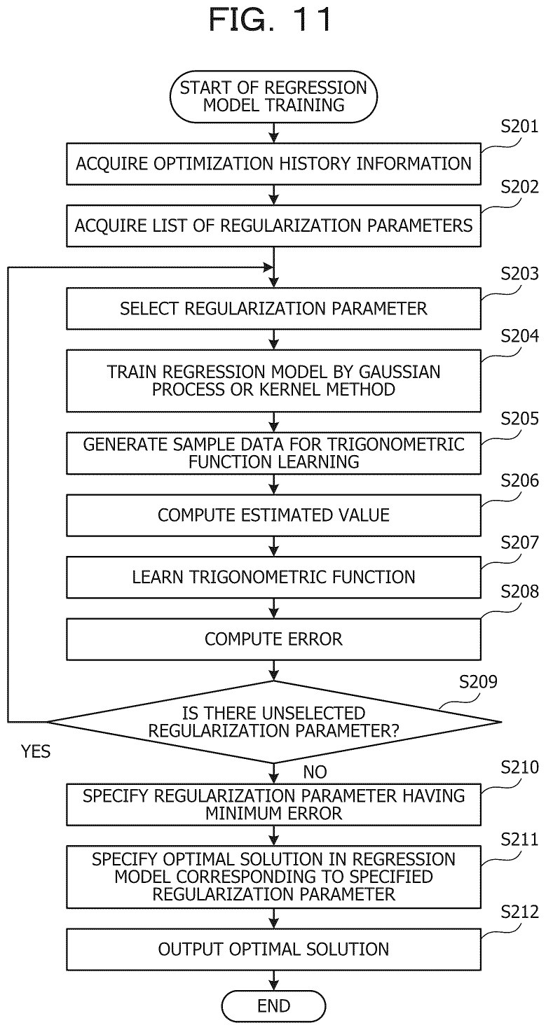

FIG. 11 is a flowchart illustrating an example of a procedure of the regression model training processing including the adjustment of the regularization parameter. Hereinafter, the processing illustrated in FIG. 11 will be described in order of step numbers.

[Step S201] The regression model training unit 130 acquires optimization history information. The optimization history information is a history of sets of parameters and observed values (for example, energy values).

It is assumed that a parameter of the quantum circuit is xₙ. xₙ is a vector of R^{d} (R^{d} is a real number space in which a number of dimensions is d (a natural number)). n={1, 2, . . . , and N} (N is a number of iterations of optimization processing). x_{N} is a solution obtained in the optimization processing.

It is assumed that a measurement result when the quantum circuit having xₙ as the parameter is executed by the quantum computer 200 is yₙ. At this time, history information is {x₁, y₁), (x₂, y₂), . . . , and (x_{N}, y_{N})}.

[Step S202] The regression model training unit 130 acquires a list L of regularization parameters. For example, the regression model training unit 130 reads a list L prepared in advance from a memory. The list L is, for example, [10⁻⁴, 10⁻³, and 10⁻²].

[Step S203] From the list L, the regression model training unit 130 selects one of unselected regularization parameters. It is assumed that the selected regularization parameter is λ (λ∈L).

[Step S204] By applying the selected regularization parameter λ, the regression model training unit 130 trains a regression model (regression model candidate) by a Gaussian process or a kernel method by using the history information.

[Step S205] The regression model training unit 130 generates sample data for trigonometric function learning. For example, the regression model training unit 130 generates “z₁, z₂, . . . , and zᵣ; zᵣ₊₁, zᵣ₊₂, . . . , and zᵣ₊ₛ ∈R^{d}” as the sample data. Among them, “z₁, z₂, . . . , and zᵣ” is used to generate a model represented by a trigonometric function. “zᵣ₊₁, zᵣ₊₂, . . . , and zᵣ₊ₛ” is used to compute an error of the generated model.

For example, the regression model training unit 130 generates the sample data by changing arbitrary one component of x_{N} (d-dimensional vector), which is an optimization solution, to a neighboring value. For example, an i-th component (1≤i≤d) of the sample data is the neighboring value of the i-th component of x_{N}, which is the optimization solution. A j-th component (1≤j≤d, j≠i) other than the i-th component of the sample data has the same value as the j-th component of z_{N}.

[Step S206] Based on the regression model obtained by the Gaussian process or the kernel method, the regression model training unit 130 computes an estimated value of each sample data. Each estimated value of “z₁, z₂, . . . , and zᵣ; zᵣ₊₁, zᵣ₊₂, . . . , and zᵣ₊ₛ” is referred to as “y₁′, y₂′, . . . , and yᵣ′; yᵣ₊₁′, yᵣ₊₂′, . . . , and yᵣ₊ₛ”.

[Step S207] The regression model training unit 130 sets, as training data, sets “(z₁, y₁′), (z₂, y₂′), . . . , and (zᵣ, yᵣ′)” of r pieces of sample data and estimated values. By using the training data, the regression model training unit 130 learns a trigonometric function “f (x)=a sin (x+x₀)+b)”. For example, the regression model training unit 130 learns values of constants “a, b, and x₀” such that a difference between f (x) and yₖ′ when “x=zₖ” (1≤k≤r) is set decreases.

[Step S208] The regression model training unit 130 computes an error of the learned trigonometric function. For example, the regression model training unit 130 obtains a value of the trigonometric function by using s pieces of sample data “zᵣ₊₁, zᵣ₊₂, . . . , and zᵣ₊ₛ” as explanatory variables of the trigonometric function. The regression model training unit 130 sets values of the obtained trigonometric function as “yᵣ₊₁′, yᵣ₊₂″, . . . , and yᵣ₊ₛ″”. The regression model training unit 130 computes an error between “yᵣ₊₁′, yᵣ₊₂′, . . . and yᵣ₊ₛ′” and “yᵣ₊₁″, yᵣ₊₂″, . . . , and yᵣ₊ₛ″”. For example, the regression model training unit 130 sets a maximum value of “yₘ′−y″ₘ″ (r+1≤m≤r+s)” as the error. The error is represented by Expression (13) below.

$${max}_{i} \vert {y}_{r + i}^{′} - {y}_{r + i}^{″} \vert \qquad ( 13 )$$

A regression model candidate having a smaller error may be determined to have higher consistency with the trigonometric function.

[Step S209] The regression model training unit 130 determines whether there is an unselected regularization parameter. When there is an unselected regularization parameter, the regression model training unit 130 causes the processing to proceed to step S203. When all the regularization parameters have been selected, the regression model training unit 130 causes the processing to proceed to step S210.

[Step S210] The regression model training unit 130 specifies a regularization parameter having a minimum error as an optimal regularization parameter. The regression model training unit 130 specifies the regression model candidate generated by using the specified regularization parameter, as a regression model for estimating an optimal solution with a reduced influence of noise.

[Step S211] The regression model training unit 130 specifies, as the optimal solution, a parameter value that minimizes energy in a regression model corresponding to the specified regularization parameter. For example, the regression model training unit 130 specifies, as the optimal solution x*, a parameter value that minimizes an estimated value of the function in the vicinity of x_{N} in the function defining the regression model.

[Step S212] The regression model training unit 130 outputs the optimal solution.

As described above, an appropriate regularization parameter is specified, and an optimal solution based on a regression model generated by using history information of optimization processing using the regularization parameter is output. Accordingly, even when the appropriate regularization parameter is unknown, it is possible to obtain an optimal solution using the appropriate regularization parameter.

### OTHER EMBODIMENTS

Although optimization processing by the VQE is performed in the second and third embodiments, the method for specifying an optimal solution described in the second and third embodiments may be applied to computation results using a method other than the VQE.

The embodiments are exemplified above, the configuration of each unit described in the embodiments may be replaced with another unit having the same function. Arbitrary other components or processes may be added. Arbitrary two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a quantum computation support program for causing a computer to execute a process comprising:
training a regression model in which parameter values are explanatory variables and computation results of quantum computation are objective variables, based on a correspondence relationship between the computation results for each of a plurality of times of quantum computation for each of the parameter values according to a quantum circuit that includes parameters and the parameter values set in the quantum computation; and
specifying a solution of the quantum computation by using the regression model.

2. The non-transitory computer-readable recording medium according to claim 1, wherein
in the training of the regression model, the regression model is trained by using a Gaussian process or a kernel method.

3. The non-transitory computer-readable recording medium according to claim 2, wherein
in the training of the regression model, uncertainty of estimation of the objective variable according to the explanatory variable of the regression model is computed by the Gaussian process or the kernel method, and
in the specifying the solution of the quantum computation, the solution of the quantum computation is specified from a range of values of the explanatory variable in which the uncertainty of estimation of the objective variable is equal to or greater than a predetermined value.

4. The non-transitory computer-readable recording medium according to claim 1, wherein
in the training of the regression model, the regression model is trained based on a correspondence relationship between the parameter values for each of the plurality of times of quantum computation for obtaining a ground state of a quantum multi-body system and the computation results of the quantum computation.

5. The non-transitory computer-readable recording medium according to claim 4, the quantum computation support program further causing the computer to execute a process of:
acquiring the correspondence relationship between the computation results of the quantum computation and the parameter values by repeatedly executing processing of updating the parameter values in a direction in which the computation results of the quantum computation approach the ground state and processing of causing a quantum computer to execute a gate operation according to the quantum circuit in which the updated parameter values are set and calculating the computation results based on a measurement result by the quantum computer.

6. The non-transitory computer-readable recording medium according to claim 1, wherein
in the specifying the solution of the quantum computation, a value of the explanatory variable at which a value of the objective variable takes an extreme value in the regression model is specified as the solution of the quantum computation.

7. The non-transitory computer-readable recording medium according to claim 1, wherein
in the training of the regression model, regression model candidates to which each of a plurality of regularization parameters is applied are trained based on the correspondence relationship between the computation results of the quantum computation and the parameter values, and the regression model is determined based on a predetermined condition from among the regression model candidates of each of the plurality of regularization parameters.

8. The non-transitory computer-readable recording medium according to claim 7, wherein
in the training of the regression model, the regression model is determined based on consistency with a trigonometric function from among the regression model candidates to which each of the plurality of regularization parameters is applied.

9. A quantum computation support method for causing a computer to execute a process comprising:
training a regression model in which parameter values are explanatory variables and computation results of quantum computation are objective variables, based on a correspondence relationship between the computation results for each of a plurality of times of quantum computation for each of the parameter values according to a quantum circuit that includes parameters and the parameter values set in the quantum computation; and
specifying a solution of the quantum computation by using the regression model.

10. An information processing apparatus comprising:
a memory; and
a processor coupled to the memory and configured to:
train a regression model in which parameter values are explanatory variables and computation results of quantum computation are objective variables, based on a correspondence relationship between the computation results for each of a plurality of times of quantum computation for each of the parameter values according to a quantum circuit that includes parameters and the parameter values set in the quantum computation; and
specify a solution of the quantum computation by using the regression model.
